(19) United States
(12) Patent Application Publication
(10) Pub. No.: US 2020/0182612 A1
(43) Pub. Date: Jun. 11, 2020

(54) Range Finder

(71) Applicants: Sintai Optical (Shenzhen) Co., Ltd., ShenZhen City (CN); Asia Optical Co., Inc., Taichung (TW)

(72) Inventors: Xin-Xin Lu, ShenZhen City (CN); Hua-Tang Liu, Taichung (TW); Sheng Luo, ShenZhen City (CN); Han Lu, ShenZhen City (CN); Peng-Fei Song, ShenZhen City (CN)

(21) Appl. No.: 16/684,628

(22) Filed: Nov. 15, 2019

(30) Foreign Application Priority Data
Dec. 6, 2018 (CN) 201811486635.1

(51) Int. Cl. G01C 3/08; G01S 17/08; G01S 17/88; A63B 57/00; F41G 1/473

(52) U.S. Cl. CPC G01C 3/08; G01S 17/08; G01S 17/88; A63B 2220/805; F41G 1/473; A63B 2220/20; A63B 57/00

(57) ABSTRACT

A range finder includes an image capturing module, a transceiver module, a switching module, an output device and a processing unit. The image capturing module is configured to receive a first light beam emitted by an object. The transceiver module is configured to emit a second light beam to the object and receive the second light beam reflected by the object for obtaining a distance between the range finder and the object. The switching module is configured to output an electrical signal corresponding to a selected operating mode selected from a plurality of operating modes. The output device is configured to show the selected operating mode corresponding to the electrical signal. The processing unit is connected to the image capturing module, the transceiver module and the output device for receiving the electrical signal and controlling the image capturing module, the transceiver module and the output device.

### BACKGROUND OF THE INVENTION

### Field of the Invention

The invention relates to a range finder, and more particularly to a range finder capable of switching operating mode.

### Description of the Related Art

Conventionally, there are two kinds of range finders respectively targeted at two different markets (e.g. hunting and golf) for satisfying requirements of different customers.

### BRIEF SUMMARY OF THE INVENTION

The invention provides a range finder, wherein at least two functions are combined into the range finder by a switching module for satisfying requirements of different customers.

The range finder in accordance with an embodiment of the invention includes an image capturing module, a transceiver module, a switching module, an output device and a processing unit. The image capturing module is configured to receive a first light beam emitted by an object for displaying an image of the object. The transceiver module is configured to emit a second light beam to the object and receive the second light beam reflected by the object for obtaining a distance between the range finder and the object. The switching module is configured to output an electrical signal corresponding to a selected operating mode which is selected from a plurality of operating modes. The output device is configured to show the selected operating mode corresponding to the electrical signal. The processing unit is electrically connected to the image capturing module, the transceiver module and the output device for receiving the electrical signal and controlling the image capturing module, the transceiver module and the output device according to the electrical signal.

In another embodiment, the switching module includes a circuit unit and a plurality of triggering elements, and one of the triggering elements corresponding to the selected operating mode is selected to connect to the circuit unit for triggering the circuit unit to output the electrical signal.

In yet another embodiment, the triggering elements include an open-circuit component, a short-circuit component and an electrical component. An open circuit is created at a terminal of the circuit unit connected to the open-circuit component when what is selected from the triggering elements is the open-circuit component. A short circuit is created at a terminal of the circuit unit connected to the short-circuit component when what is selected from the triggering elements is the short-circuit component. The electrical component and a portion of the circuit unit are connected in parallel to provide an equivalent resistance when what is selected from the triggering elements is the electrical component.

In another embodiment, the open-circuit component comprises plastic or rubber, the short-circuit component comprises copper or silver, and the electrical component comprises a resistor.

In yet another embodiment, the operating modes includes a hunting mode and a golf mode. When the processing unit judges the operating mode to be the hunting mode, the processing unit controls the image capturing module and the transceiver module for obtaining the image of the object and firing information corresponding to the object. When the processing unit judges the operating mode to be the golf mode, the processing unit controls the image capturing module and the transceiver module for obtaining the image of the object and location information corresponding to the object.

In another embodiment, the image capturing module includes an objective lens unit, an erecting unit and a display unit, the objective lens unit is configured to receive the first light beam, the erecting unit is configured to convert the first light beam into an erecting image and focus the erecting image on the display unit, and the display unit is configured to display the image of the object and value of the distance between the range finder and the object.

In yet another embodiment, the image capturing module further includes an eyepiece unit, through which the image of the object displayed on the display unit is observed.

In another embodiment, the transceiver module includes a light-emitting unit and a receiving unit, the light-emitting unit is configured to emit the second light beam, the receiving unit is configured to receive the second light beam and output a signal to the processing unit, and the processing unit is configured to receive the signal for calculating the distance between the range finder and the object.

In yet another embodiment, the light-emitting unit is a laser diode, and the receiving unit is an avalanche photodetector.

In another embodiment, the first light beam is visible light, and the second light beam is invisible light.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a range finder in accordance with a first embodiment of the invention;

FIG. 2 is a block diagram of a switching module of the FIG. 1;

FIG. 3A is a circuit diagram of a circuit unit and a triggering element corresponding to a hunting mode in accordance with the first embodiment of the invention;

FIG. 3B is a circuit diagram of a circuit unit and a triggering element corresponding to a golf mode in accordance with the first embodiment of the invention.

### DETAILED DESCRIPTION OF THE INVENTION

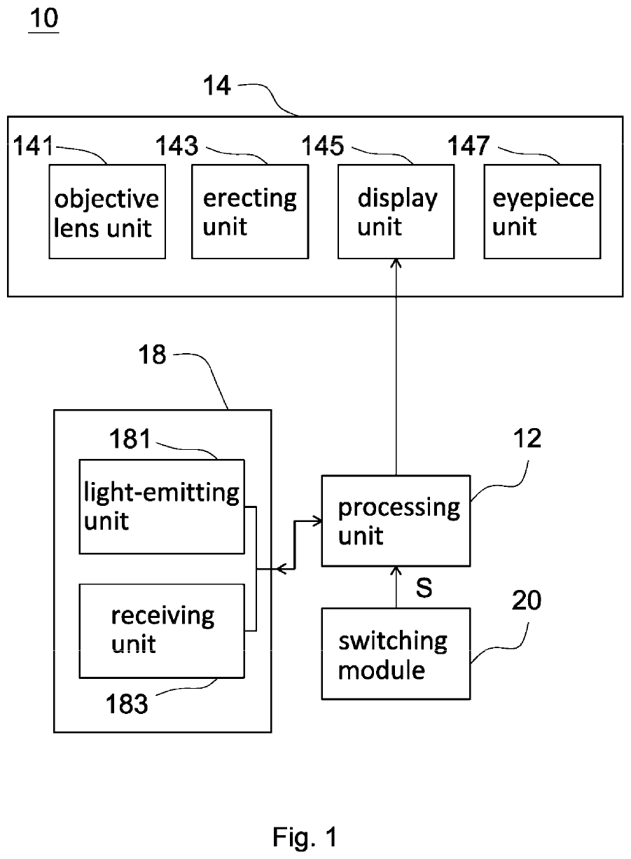

Referring to FIG. 1, a range finder 10 in accordance with a first embodiment of the invention includes a processing unit 12, an image capturing module 14, a transceiver module 18 and a switching module 20, wherein the range finder 10 has a plurality of operating modes. A user can select any of the operating modes by operating the switching module 20. The processing unit 12 is configured to judge the operating mode selected by the user by receiving an electrical signal S outputted by the switching module 20 and control the image capturing module 14 and the transceiver module 18 according to the selected operating mode, so that the user can operate the range finder 10 in the selected operating mode.

The image capturing module 14 includes an objective lens unit 141, an erecting unit 143, a display unit 145 and an eyepiece unit 147. The display unit 145 includes an optical sensor (not shown) and a display (not shown). In operation, the range finder 10 is aimed at an object (not shown), the objective lens unit 141 receives a first light beam (not shown) emitted by the object, the erecting unit 143 converts the first light beam into an erecting image and focuses the erecting image on the optical sensor, the optical sensor converts the erecting image into an electrical signal (not shown) and outputs the electrical signal to the display, and the display displays an image of the object. Then, the user can observe the image of the object through the eyepiece unit 147.

The transceiver module 18 includes a light-emitting unit 181 and a receiving unit 183. In operation, the processing unit 12 controls the light-emitting unit 181 to emit a second light beam (not shown), the second light beam leaves the range finder 10, arrives at the object, is reflected back to the range finder 10 by the object and is received by the receiving unit 183, the receiving unit 183 receives the second light beam and outputs a signal (not shown) to the processing unit 12, the processing unit 12 receives the signal to calculate a distance between the range finder 10 and the object, and a value of the distance is displayed by the display unit 145 for being observed by the user.

In the first embodiment, the first light beam is visible light, and the second light beam is invisible light. The light-emitting unit 181 is a laser diode (LD), the receiving unit 183 is an avalanche photodetector (APD), the optical sensor is a charge-coupled device (CCD), and the display is a liquid crystal display (LCD) or organic light-emitting diode (OLED).

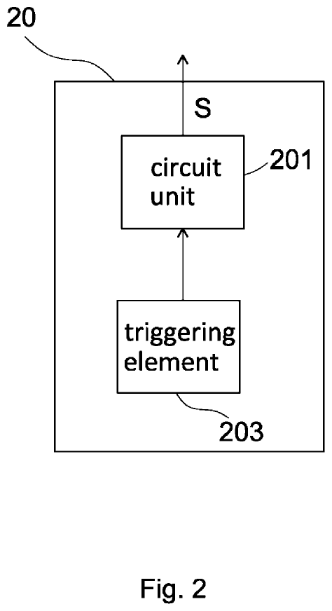

Referring to FIG. 2, the switching module 20 includes a circuit unit 201 and a plurality of triggering elements 203. Each of the triggering elements 203 corresponds to one of the operating modes of the range finder 10. As shown in FIGS. 1 and 2, any one of the triggering elements 203 can be selectively connected to the circuit unit 201. A connection of a triggering element 203 to the circuit unit 201 triggers the circuit unit 201 to output the electrical signal S to the processing unit 12. The processing unit 12 receives the electrical signal S, judges the operating mode corresponding to the selected triggering element 203 and controls the image capturing module 14 and transceiver module 18 to operate according to the operating mode. It is worth noting that each of the triggering elements 203 can be detachably connected to the circuit unit 201. Therefore, the operating mode of the range finder 10 can be switched by changing one triggering element 203 to another. In the present embodiment, the triggering elements 203 are detachable covers for the range finder 10. The covers are of different colors representing different operating modes, so that the user is able to recognize the operating mode of the range finder 10. Further, the covers have triggering points arranged in different ways or in different positions for triggering the circuit unit 201 to output the electrical signal S. In another embodiment, the covers can be substituted by a single cover which includes a movable triggering point, and movement of the triggering point can be controlled from the outside of the cover by a user for switching the operating mode of the range finder 10. Also, the user can observe the position of the triggering point from the outside of the cover to recognize the operating mode of the range finder 10.

In yet another embodiment, the range finder 10 further includes an output device (not shown) electrically connected to the processing unit 12. The processing unit 12 receives the electrical signal S and presents the information of the operating mode corresponding to the electrical signal S through the output device, so that the user is able to recognize the operating mode of the range finder 10. The output device may be a display device or indicating lamp, wherein the display device can show different words or letters to represent different operating modes, while the indicating lamp can emit light of different colors to represent different operating modes. The processing unit 12 may be a micro control unit (MCU).

In the first embodiment, the operating modes of the range finder 10 include a hunting mode and a golf mode. The operation of the hunting mode and the golf mode are described below.

<The Hunting Mode>

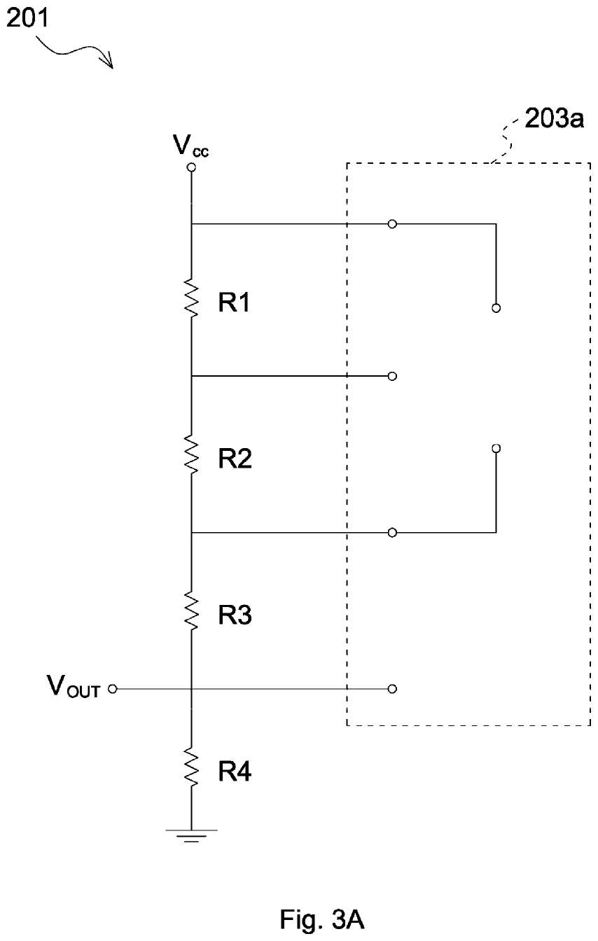

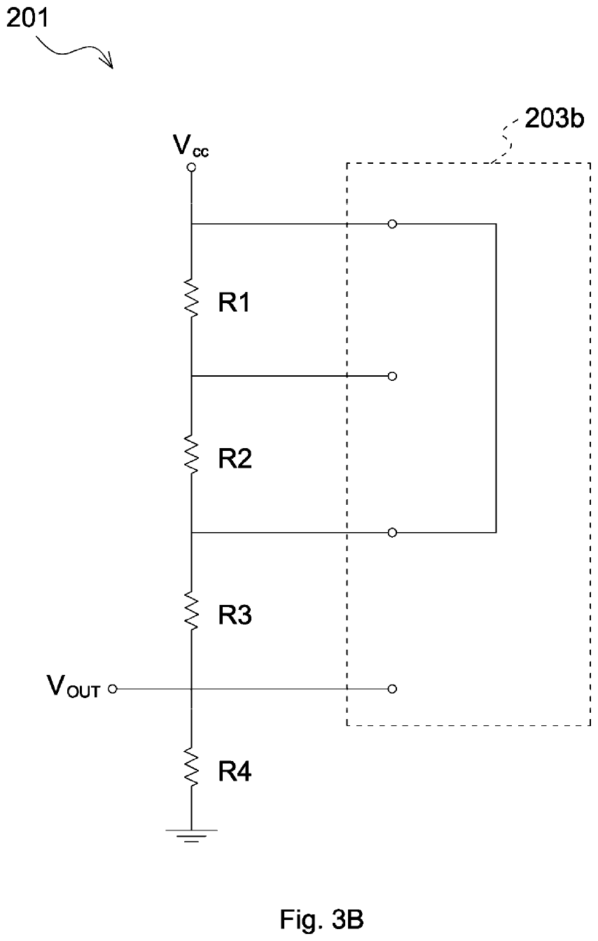

When a triggering element 203a corresponding to the hunting mode is fitted to the range finder 10 and the range finder 10 is aimed at the target, the firing information (e.g. distance between user and target or amount for correcting bullet impact point) from a target (e.g. animal) can be obtained. Referring to FIG. 3A, in the first embodiment, the circuit unit 201 includes a bleeder circuit, and the triggering element 203a corresponding to the hunting mode includes an open-circuit component (e.g. plastic, rubber or other nonconductive component). An open circuit is created at a terminal of the circuit unit 201 connected to the open-circuit component, so that an output voltage Vₒᵤₜ (that is, the electrical signal S) of the circuit unit 201 remains unchanged. The circuit unit 201 satisfies the following condition (1):

Vₒᵤₜ=V_{cc}×R4/(R1+R2+R3+R4) (1)

wherein V_{cc} is a bias voltage, and R1, R2, R3 and R4 are all resistance.

The processing unit 12 receives the output voltage Vₒᵤₜ, judges from a value of the output voltage Vₒᵤₜ that the operating mode selected by the user is the hunting mode, and controls the image capturing module 14 and the transceiver module 18 for obtaining an image of the target and the firing information corresponding to the target. Then, the image of the target and the firing information are displayed by the display unit 145, so that the user can observe the image of the target and the firing information through the eyepiece unit 147.

<The Golf Mode>

When a triggering element 203b corresponding to the golf mode is fitted to the range finder 10 and the range finder 10 is aimed at a target flagstick on a golf course, the position information (e.g. actual distance, horizontal distance, angle of slope, height or hint of uphill and downhill) from the target flagstick can be obtained. Referring to FIG. 3B, the triggering element 203b corresponding to the golf mode is a short-circuit component (e.g. copper, silver or other conductive component). A short circuit is created at a terminal of the circuit unit 201 connected to the short-circuit component, so that the output voltage Vₒᵤₜ of the circuit unit 201 is changed. The circuit unit 201 satisfies the following condition (2):

Vₒᵤₜ=V_{cc}×R4/(R3+R4) (2).

The processing unit 12 receives the output voltage Vₒᵤₜ, judges from a value of the output voltage Vₒᵤₜ that the operating mode selected by the user is the golf mode, and controls the image capturing module 14 and the transceiver module 18 for obtaining an image of the target flagstick and the position information corresponding to the target flagstick. Then, the image of the target flagstick and the position information are displayed by the display unit 145, so that the user can observe the image of the target flagstick and the position information through the eyepiece unit 147.

In a second embodiment, the triggering element 203 corresponding to the golf mode includes an electrical component (e.g. resistor). The electrical component and a portion of the circuit unit 201 are connected in parallel for providing an equivalent resistance, so that the output voltage Vₒᵤₜ of the circuit unit 201 is changed. The arrangement of other elements and operation of the second embodiment are similar to those of the first embodiment described above, and therefore the descriptions thereof are omitted.

It is understood that the triggering element 203 corresponding to the hunting mode is not limited to the short-circuit component, and the triggering element 203 corresponding to the golf mode is not limited to the open-circuit component or the electrical component, either. In brief, the triggering element 203 corresponding to the hunting mode and the triggering element 203 corresponding to the golf mode are provided for changing the output voltage Vₒᵤₜ of the circuit unit 201 in different degrees, so that the processing unit 12 is able to judge the operating mode selected by the user.

In addition to the described hunting mode and golf mode, the range finder of a third embodiment has a high accuracy mode, a low accuracy mode, an environment sensing mode and a wireless transmission mode. That is, six triggering elements are provided corresponding to the six operating modes for changing the output voltage of the circuit unit in different degrees, so that the processing unit is able to judge the operating mode selected by the user. From the above embodiments, it is understood that the range finder of the invention can be modified to have different number of operating modes and triggering elements to meet the requirements of users.

An example is described herein but not limited thereto. Three output voltages Vₒᵤₜ₁, Vₒᵤₜ₂, Vₒᵤₜ₃ changed according to three different operating modes are showed in Table 1. The operating modes are but not limited to a hunting mode, a golf mode and a golf competition mode, wherein some functions (e.g. function for detecting angle of slope) of the golf mode are unavailable for the golf competition mode in order to meet the rules of golf competition.

TABLE 1

| | Output Voltage | Output Voltage | Output Voltage |
|---|---|---|---|
| Operating Mode | Vₒᵤₜ₁ | Vₒᵤₜ₂ | Vₒᵤₜ₃ |
| Golf | 1 | 0.5 | 0.8 |
| Golf Competition | 2 | 1.0 | 1.6 |
| Hunting | 3 | 1.5 | 2.4 |

TABLE 2

| | Output Voltage | Output Voltage | Output Voltage |
|---|---|---|---|
| | Vₒᵤₜ₁ | Vₒᵤₜ₂ | Vₒᵤₜ₃ |
| Average Difference X | 1 | 0.5 | 0.8 |
| Maximal Difference Y | 2 | 1.0 | 1.6 |
| Number of Operating | 3 | 3 | 3 |
| Mode Z | | | |
| Y/Z | 0.667 | 0.333 | 0.533 |
| X/Y | 0.5 | 0.5 | 0.5 |
| X/Z | 0.333 | 0.167 | 0.267 |

Referring to Tables 1-2, some parameters shown in Table 2 are obtained from Table 1, for example the average difference X, the maximal difference Y and the number of operating mode Z. The maximal difference Y of the output voltage is a result that a maximal output voltage minus a minimal output voltage. As shown in Table 2, the range finder 10 satisfies the following conditions (3)-(5):

0.333≤Y/Z≤0.667 (3)

0.25≤X/Y≤0.5 (4)

0.167≤X/Z≤0.333 (5).

Considering the tolerance range of plus or minus 5%, the conditions (3)-(5) can be amended to following conditions (6)-(8):

0.317≤Y/Z≤0.7 (6)

0.236≤Y/Z≤0.525 (7)

0.159≤Y/Z≤0.35 (8).

In sum, due to the switching module 20, at least two operating modes (the hunting mode and the golf mode) are combined into the range finder 10 of the invention for satisfying requirements of different customers. Therefore, the added value of product is increased, and the application of product is broadened.

What is claimed is:

1. A range finder, comprising:
an image capturing module configured to receive a first light beam emitted by an object for displaying an image of the object;
a transceiver module configured to emit a second light beam to the object and receive the second light beam reflected by the object for obtaining a distance between the range finder and the object;
a switching module configured to output an electrical signal corresponding to a selected operating mode which is selected from a plurality of operating modes;
an output device configured to show the selected operating mode corresponding to the electrical signal; and
a processing unit electrically connected to the image capturing module, the transceiver module and the output device for receiving the electrical signal and controlling the image capturing module, the transceiver module and the output device according to the electrical signal.

2. The range finder as claimed in claim 1, wherein the switching module comprises a circuit unit and a plurality of triggering elements, and one of the triggering elements corresponding to the selected operating mode is selected to connect to the circuit unit for triggering the circuit unit to output the electrical signal.

3. The range finder as claimed in claim 2, wherein:
the triggering elements comprise an open-circuit component;
an open circuit is created at a terminal of the circuit unit connected to the open-circuit component when what is selected from the triggering elements is the open-circuit component.

4. The range finder as claimed in claim 3, wherein:
the triggering elements further comprise a short-circuit component;
a short circuit is created at a terminal of the circuit unit connected to the short-circuit component when what is selected from the triggering elements is the short-circuit component.

5. The range finder as claimed in claim 4, wherein:
the triggering elements further comprise an electrical component;
the electrical component and a portion of the circuit unit are connected in parallel to provide an equivalent resistance when what is selected from the triggering elements is the electrical component.

6. The range finder as claimed in claim 2, wherein:
the triggering elements comprise a short-circuit component;
a short circuit is created at a terminal of the circuit unit connected to the short-circuit component when what is selected from the triggering elements is the short-circuit component.

7. The range finder as claimed in claim 2, wherein:
the triggering elements comprise an electrical component;
the electrical component and a portion of the circuit unit are connected in parallel to provide an equivalent resistance when what is selected from the triggering elements is the electrical component.

8. The range finder as claimed in claim 3, wherein:
the triggering elements further comprise an electrical component;
the electrical component and a portion of the circuit unit are connected in parallel to provide an equivalent resistance when what is selected from the triggering elements is the electrical component.

9. The range finder as claimed in claim 3, wherein the open-circuit component comprises plastic or rubber.

10. The range finder as claimed in claim 4, wherein the short-circuit component comprises copper or silver.

11. The range finder as claimed in claim 5, wherein the electrical component comprises a resistor.

12. The range finder as claimed in claim 1, wherein:
the operating modes comprises a hunting mode and a golf mode;
when the processing unit judges the operating mode to be the hunting mode, the processing unit controls the image capturing module and the transceiver module for obtaining the image of the object and firing information corresponding to the object;
when the processing unit judges the operating mode to be the golf mode, the processing unit controls the image capturing module and the transceiver module for obtaining the image of the object and location information corresponding to the object.

13. The range finder as claimed in claim 1, wherein the image capturing module comprises an objective lens unit, an erecting unit and a display unit, the objective lens unit is configured to receive the first light beam, the erecting unit is configured to convert the first light beam into an erecting image and focus the erecting image on the display unit, and the display unit is configured to display the image of the object and value of the distance between the range finder and the object.

14. The range finder as claimed in claim 13, wherein the image capturing module further comprises an eyepiece unit, through which the image of the object displayed by the display unit is observed.

15. The range finder as claimed in claim 1, wherein the transceiver module comprises a light-emitting unit and a receiving unit, the light-emitting unit is configured to emit the second light beam, the receiving unit is configured to receive the second light beam and output a signal to the processing unit, and the processing unit is configured to receive the signal for calculating the distance between the range finder and the object.

16. The range finder as claimed in claim 15, wherein the light-emitting unit is a laser diode, and the receiving unit is an avalanche photodetector.

17. The range finder as claimed in claim 1, wherein the first light beam is visible light, and the second light beam is invisible light.
